(19) United States
(12) Patent Application Publication
(10) Pub. No.: US 2022/0306541 A1
(43) Pub. Date: Sep. 29, 2022

(54) FERRITE COMPOSITION AND ELECTRONIC COMPONENT

(71) Applicant: TDK CORPORATION, Tokyo (JP)

(72) Inventors: Kouichi KAKUDA, Tokyo (JP); Takashi SUZUKI, Tokyo (JP); Yukio TAKAHASHI, Tokyo (JP); Kunihiko KAWASAKI, Tokyo (JP); Hiroyuki TANOUE, Tokyo (JP); Takehiro ISHII, Tokyo (JP); Takuya NIIBORI, Tokyo (JP); Takahiro SATO, Tokyo (JP); Akihiko OIDE, Tokyo (JP); Yasuhiro ITO, Tokyo (JP); Takashi ENDO, Tokyo (JP); Kunio ODA, Tokyo (JP)

(73) Assignee: TDK CORPORATION, Tokyo (JP)

(21) Appl. No.: 17/699,972

(22) Filed: Mar. 21, 2022

(30) Foreign Application Priority Data
Mar. 24, 2021 (JP) 2021-050234

(51) Int. Cl. C04B 35/26

(52) U.S. Cl. CPC C04B 35/2633; C04B 2111/00844

(57) ABSTRACT

A ferrite composition comprises a main component and a subcomponent. The main component includes 32.0 to 46.4 mol % of iron oxide in terms of Fe₂O₃, 4.4 to 14.0 mol % of copper oxide in terms of CuO, and 8.4 to 56.9 mol % of zinc oxide in terms of ZnO. The subcomponent includes 0.53 to 11.00 parts by weight of a silicon compound in terms of SiO₂, 0.1 to 12.8 parts by weight of a tin compound in terms of SnO₂, and 0.5 to 7.0 parts by weight of a bismuth compound in terms of Bi₂O₃, with respect to 100 parts by weight of the main component.

### TECHNICAL FIELD

The present invention relates to a ferrite composition and an electronic component.

### BACKGROUND

A higher frequency band is more widely used recently for a smartphone, a computer, etc. A number of standards for several-GHz bands are already available. A demand for a noise removal product for a high frequency signal has been increasing. An example of the noise removal product is a multilayer chip coil.

Electric properties of the multilayer chip coil can be evaluated in terms of impedance. Up to a 100 MHz band, impedance properties are largely affected by permeability of a material of a device body and frequency properties. Additionally, impedance properties of a GHz band are affected by stray capacitance between electrodes facing each other in the multilayer chip coil. A method of reducing the stray capacitance between the electrodes facing each other in the multilayer chip coil is reduction of permittivity between the facing electrodes.

It is currently common for a Ni—Cu—Zn-based ferrite to be used as the material of the device body of the multilayer chip coil, as is proposed in Patent Literature 1, for example Because the ferrite is fired at the same time with Ag used as an internal electrode, the ferrite is chosen for being magnetic ceramic that can be fired at a temperature of 900° C. However, it is normally difficult to reduce permittivity of the Ni—Cu—Zn-based ferrite, and there needs to be a way of improvement.

Accordingly, a demand for reduction of the permittivity between the facing electrodes and reduction of the stray capacitance in the multilayer coil using the Ni—Cu—Zn-based ferrite is growing so that the multilayer coil can have excellent practicality in the GHz band.

Patent Literature 1: JP Patent Application Laid Open No. 2002-175916

### BRIEF SUMMARY OF THE INVENTION

The present invention has been achieved under such circumstances. It is an object of the invention to provide a ferrite composition having low relative permittivity and excellent DC bias characteristic as well as an electronic component including the ferrite composition.

To achieve the above object, a ferrite composition according to the present invention is a ferrite composition comprising a main component and a subcomponent, wherein the main component includes 32.0 to 46.4 mol % of iron oxide in terms of Fe₂O₃, 4.4 to 14.0 mol % of copper oxide in terms of CuO, and 8.4 to 56.9 mol % of zinc oxide in terms of ZnO; and the subcomponent includes 0.53 to 11.00 parts by weight of a silicon compound in terms of SiO₂, 0.1 to 12.8 parts by weight of a tin compound in terms of SnO₂, and 0.5 to 7.0 parts by weight of a bismuth compound in terms of Bi₂O₃, with respect to 100 parts by weight of the main component.

With the above features, the ferrite composition according to the present invention can have reduced relative permittivity while having excellent DC bias characteristic.

The subcomponent of the ferrite composition according to the present invention may include 0.01 to 15.0 parts by weight of cobalt oxide in terms of Co₃O₄ with respect to 100 parts by weight of the main component.

The ferrite composition according to the present invention may include crystal grains with higher Sn concentration on a surface side than in a central portion.

The ferrite composition according to the present invention may include crystal grains with higher Si concentration on a surface side than in a central portion.

An electronic component according to the present invention includes the above ferrite composition.

Including the above ferrite composition, the electronic component can have reduced stray capacitance due to reduced relative permittivity, as well as excellent DC bias characteristic.

### BRIEF DESCRIPTION OF THE DRAWING(S)

FIG. 1 is a transparent perspective view inside a multilayer chip coil as an electronic component according to an embodiment of the present invention.

FIG. 2 is a transparent perspective view inside a multilayer chip coil as an electronic component according to another embodiment of the present invention.

FIG. 3A is a schematic diagram showing a cross section of a crystal grain included in a ferrite composition according to an embodiment of the present invention.

FIG. 3B is a schematic diagram showing a cross section of a crystal grain included in a ferrite composition according to an embodiment of the present invention.

FIG. 4 is a STEM-EDS image of a ferrite composition (sample No. 16) according to an example of the present invention.

FIG. 5 is a STEM-EDS image of a ferrite composition (sample No. 13) that does not include tin oxide as a subcomponent.

FIG. 6 is a Sn element mapping image of a ferrite composition (sample No. 16) according to an example of the present invention.

FIG. 7 is a Sn element mapping image of a ferrite composition (sample No. 13) that does not include tin oxide as a subcomponent.

FIG. 8A is a STEM-EDS image of a ferrite composition (sample No. 16) according to an example of the present invention.

FIG. 8B is an enlarged view of the area in the dotted frame in FIG. 8A and shows a location of Sn concentration measurement.

FIG. 9A is a graph showing changes in the amount (wt %) of Fe₂O₃, SnO₂, and SiO₂ from point I to point II shown in FIG. 8B.

FIG. 9B is a graph same as FIG. 9A but has a magnified vertical axis.

### DETAILED DESCRIPTION OF THE INVENTION

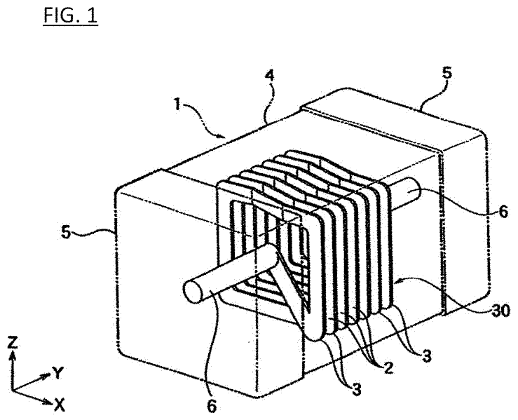

Hereinafter, the present invention is described based on the embodiments shown in the figures. As shown in FIG. 1, a multilayer chip coil 1 as an electronic component according to an embodiment of the present invention includes a chip body 4 containing ceramic layers 2 and internal electrode layers 3 alternately laminated in the Y-axis direction.

Each of the internal electrode layers 3 has a square ring shape, a C shape, or a U shape. The internal electrode layers 3 are spirally connected with a stepped electrode or a through-hole electrode (not shown in the figure) penetrating the adjacent ceramic layers 2 to connect the internal electrodes, constituting a coil conductor 30.

Terminal electrodes 5 and 5 are formed on both ends of the chip body 4 in the Y-axis direction. Each of the terminal electrodes 5 is connected with an end of a terminal-connection through-hole electrode 6 penetrating the laminated ceramic layers 2 so that each of the electrode terminals 5 and 5 is connected to each end of the coil conductor 30 forming a closed magnetic circuit coil (winding wire pattern).

In the present embodiment, the ceramic layers 2 and the internal electrode layers 3 are laminated in the Y-axis direction, and the end surfaces of the terminal electrodes 5 and 5 are parallel to the X-axis and the Z-axis. The X-axis, the Y-axis, and the Z-axis are perpendicular to each other. In the multilayer chip coil 1 shown in FIG. 1, the winding axis of the coil conductor 30 substantially corresponds to the Y-axis.

The shape or the dimensions of the chip body 4 are not limited and can be determined appropriately based on usage. Normally, the shape is substantially rectangular parallelepiped. For example, the dimension in the X-axis direction is 0.15 to 0.8 mm, the dimension in the Y-axis direction is 0.3 to 1.6 mm, and the dimension in the Z-axis direction is 0.1 to 1.0 mm.

The ceramic layers 2 have any thickness between the electrodes and any base thickness. The ceramic layers 2 can have a thickness between the electrodes (an interval between the internal electrode layers 3 and 3) of about 3 to 50 μm and a base thickness (a length of the terminal-connection through-hole electrode 6 in the Y-axis direction) of about 5 to 300 μm.

In the present embodiment, the terminal electrodes 5 are not limited and are formed by applying a conductive paste whose main component includes Ag, Pd, etc. onto outer surfaces of the chip body 4, then firing the paste, and further performing electroplating. Cu, Ni, Sn, etc. can be used in electroplating.

The coil conductor 30 contains Ag (including a Ag alloy) and is composed of, for example, Ag alone, a Ag—Pd alloy, or the like. The coil conductor 30 can contain Zr, Fe, Mn, Ti, and their oxides as a subcomponent.

The ceramic layers 2 are composed of a ferrite composition according to an embodiment of the present invention. Hereinafter, the ferrite composition is described in detail.

The ferrite composition according to the present embodiment contains a main component comprising an Fe compound, a Cu compound, and a Zn compound. For example, the Fe compound, the Cu compound, and the Zn compound may include iron oxide (Fe₂O₃), copper oxide (CuO), and zinc oxide (ZnO) respectively. The main component of the ferrite composition according to the present embodiment may also contain a Ni compound, such as nickel oxide (NiO).

In 100 mol % of the main component, the amount of iron oxide is, in terms of Fe₂O₃, 32.0 to 46.4 mol %, preferably 33.0 to 46.0 mol %, and more preferably 33.0 to 44.5 mol %. When the amount of iron oxide is too large, DC bias characteristic is easily degraded. When the amount of iron oxide is too little, relative permittivity is easily increased, and permeability μ′ is easily decreased. Permeability μ′ is a real part of complex permeability.

In 100 mol % of the main component, the amount of copper oxide is, in terms of CuO, 4.4 to 14.0 mol %, preferably 5.0 to 14.0 mol %, and more preferably 5.5 to 14.0 mol %. When the amount of copper oxide is too large, permeability μ′ and specific resistance are easily decreased. When the amount of copper oxide is too little, sinterability decreases, and sintering density in low temperature sintering is especially easily decreased. Specific resistance is also easily decreased due to decrease in sinterability. Further, permeability μ′ is easily decreased.

In 100 mol % of the main component, the amount of zinc oxide is, in terms of ZnO, 8.4 to 56.9 mol %, preferably 13.2 to 56.9 mol %, and more preferably 20.0 to 43.5 mol %. When the amount of zinc oxide is too large, the Curie temperature easily decreases. When the amount of zinc oxide is too little, permeability μ′ tends to decrease easily. Specific resistance also tends to decrease easily.

The main component may contain nickel oxide. In 100 mol % of the main component, the amount of nickel oxide can be 0 mol % or more, 5.0 mol % or more, or 10.0 mol % or more. The amount of nickel oxide may be 0 mol %. Because the Curie temperature decreases when the amount of nickel oxide is small, the ferrite composition according to the present embodiment can be a non-magnetic material at room temperature. By including 5.0 mol % or more nickel oxide in 100 mol % of the main component, the ferrite composition according to the present embodiment can be a magnetic material.

The ferrite composition according to the present embodiment contains a subcomponent comprising a silicon (Si) compound, a tin (Sn) compound, and a bismuth (Bi) compound, in addition to the above-mentioned main component. The subcomponent may also contain a cobalt (Co) compound, such as cobalt oxide.

The amount of the silicon compound is, in terms of SiO₂, 0.53 to 11.0 parts by weight, preferably 1.05 to 11.0 parts by weight, and more preferably 2.05 to 8.35 parts by weight, with respect to 100 parts by weight of the main component. When the amount of the silicon compound is too large, sinterability decreases, and permeability μ′ is easily decreased. When the amount of the silicon compound is too little, relative permittivity is easily increased.

The amount of the tin compound is, in terms of SnO₂, 0.1 to 12.8 parts by weight, preferably 0.8 to 11.3 parts by weight, and more preferably 2.1 to 9.4 parts by weight, with respect to 100 parts by weight of the main component. Particularly, with 0.8 parts by weight or more of the tin compound in terms of SnO₂ included with respect to 100 parts by weight of the main component, crystal grains having higher Sn concentration on a surface side than in a central portion in a main phase are easily generated. On the other hand, when the amount of the tin compound is too large, sinterability decreases, and permeability μ′ is easily decreased. When the amount of the tin compound is too little, relative permittivity is easily increased.

The amount of the bismuth compound is, in terms of Bi₂O₃, 0.5 to 7.0 parts by weight, preferably 1.1 to 3.8 parts by weight, and more preferably 1.1 to 3.0 parts by weight, with respect to 100 parts by weight of the main component. When the amount of the bismuth compound is too large, relative permittivity is easily increased, and the bismuth compound might exude in sintering. When the amount of the bismuth compound is too little, specific resistance is easily decreased. Additionally, sufficient sinterability is difficult to be obtained, and sintering density in low temperature sintering is especially easily decreased.

The amount of cobalt oxide is, in terms of Co₃O₄, preferably 0.01 to 15.0 parts by weight, more preferably 0.01 to 6.0 parts by weight, and still more preferably 0.01 to 4.0 parts by weight, with respect to 100 parts by weight of the main component. When the amount of cobalt oxide is too large, permeability μ′ is easily decreased. Additionally, permittivity is easily increased, and specific resistance is easily decreased.

The amount of each constituent of the main component and the subcomponent does not substantially change in manufacture of the ferrite composition, from a step where the ferrite composition is in a state of a raw material powder to a step after firing.

In the ferrite composition according to the present embodiment, the composition range of each constituent of the main component is controlled to the above-mentioned range. Additionally, the silicon compound, the tin compound, and the bismuth compound are contained in the subcomponent within the above-mentioned ranges. Consequently, the ferrite composition having excellent DC bias characteristic and reduced relative permittivity can be obtained. Moreover, the ferrite composition according to the present embodiment can be sintered at about 900° C., which is equal to or lower than the melting point of Ag used as the internal electrodes, and is thereby applicable to various purposes.

The ferrite composition according to the present embodiment may further include an additional component, such as manganese oxide (e.g., Mn₃O₄), zirconium oxide, magnesium oxide, a glass compound, etc., other than the above-mentioned subcomponent, as long as the effects of the present invention are not impaired. The amount of the additional component is not limited and is, for example, about 0.05 to 1.0 parts by weight with respect to 100 parts by weight of the main component.

The ferrite composition according to the present embodiment may further contain an oxide of inevitable impurity elements.

The inevitable impurity elements are elements other than the above-mentioned elements. Specifically, the inevitable impurity elements are C, S, Cl, As, Se, Br, Te, I, Li, Na, Mg, Al, Ca, Ga, Ge, Sr, Cd, In, Sb, Ba, Pb, Sc, Ti, V, Cr, Y, Nb, Mo, Pd, Ag, Hf, Ta, etc. The oxide of the inevitable impurity elements may be contained as long as its amount is about 0.05 parts by weight or less in the ferrite composition.

In particular, with 0.05 parts by weight or less of Al included in terms of Al₂O₃ with respect to 100 parts by weight of the main component, sinterability and specific resistance can be improved.

The ferrite composition according to the present embodiment includes a main phase comprising spinel ferrite. Portions other than the main phase is a subphase and a grain boundary phase. The subphase and the grain boundary phase are not limited. The subphase is a phase not comprising spinel ferrite and may comprise, for example, a Zn₂SiO₄ phase or a SiO₂ phase. The grain boundary phase may comprise, for example, a SiO₂ phase.

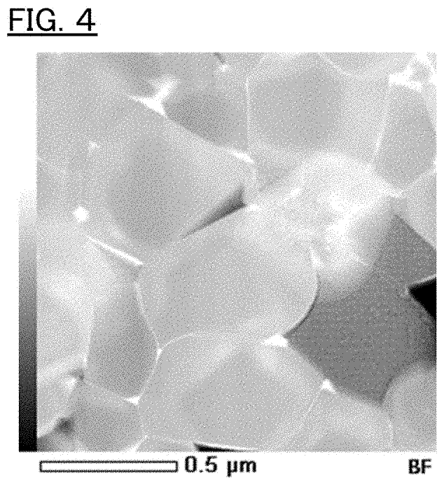

In the ferrite composition according to the present embodiment, the main phase includes crystal grains. FIG. 4 is an observation result of the ferrite composition according to the present embodiment observed with STEM-EDS. It is understood from FIG. 4 that the ferrite composition has the crystal grains.

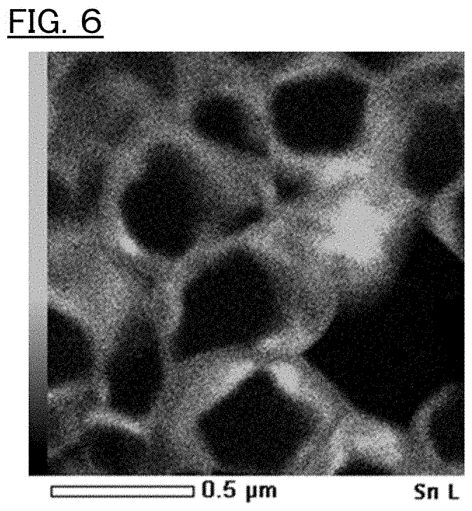

In the ferrite composition according to the present embodiment, the main phase can include crystal grains with uniform Sn concentration (hereinafter possibly abbreviated to crystal grains β) and crystal grains with higher Sn concentration on the surface side than in the central portion (hereinafter possibly abbreviated to crystal grains α). In observation of an observation region of 6 μm (length) by 6 μm (width) at a magnification of 20000, the proportion of the area occupied by the crystal grains α is preferably 30% or more and is more preferably 50% or more. FIG. 6 is an example of a Sn element mapping image of the ferrite composition according to the present embodiment observed using STEM-EDS at a magnification of 100000. The white area is where the Sn element exists. In FIG. 6, the crystal grains with higher Sn concentration on the surface side than in the central portion are observed. From FIG. 6, it is understood that the ferrite composition according to the present embodiment include the above-mentioned crystal grains α. Because the central portion of each of the crystal grains α has relatively low Sn concentration and relatively high Fe concentration, the ferrite composition including the crystal grains α can maintain excellent DC bias characteristic and permittivity. The location of the crystal grains α in the main phase is not limited.

Here, the Sn concentration means the concentration of SnO₂ in 100 wt % of oxide components constituting each of the crystal grains. The oxide components constituting the crystal grain are not limited, but include, for example, Fe₂O₃, CuO, ZnO, NiO, SiO₂, SnO₂, Bi₂O₃, and Co₃O₄. High Sn concentration means that the amount of Sn in terms of SnO₂ in 100 wt % of the oxide components constituting the crystal grain is preferably 0.30 wt % or more, more preferably 0.50 wt % or more, and still more preferably 0.65 wt % or more.

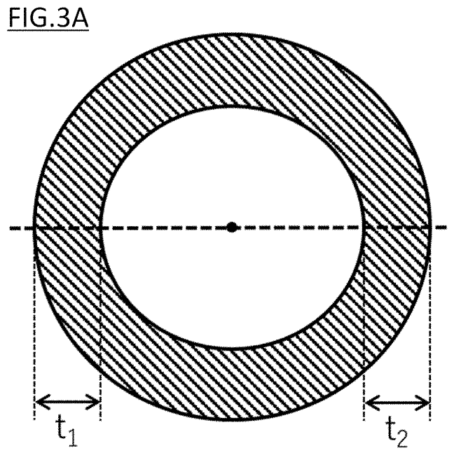

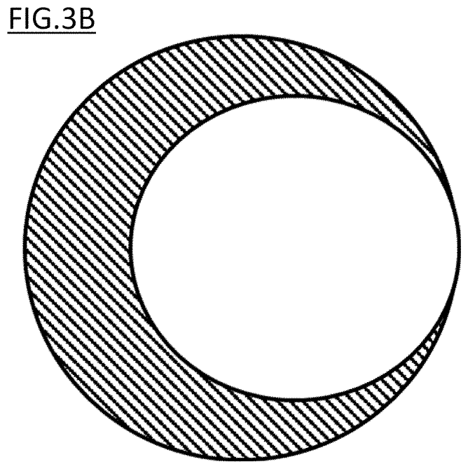

Each of FIGS. 3A and 3B is a schematic diagram showing a cross section of one of the crystal grains α. A portion with high Sn concentration in the one crystal grain α may entirely cover the surface side of the crystal grain as shown in FIG. 3A, or might not entirely cover the surface side of the crystal grain as shown in FIG. 3B. For example, when the portion with high Sn concentration is present in t₁ and t₂ inward from the surface of the crystal grain as shown in FIG. 3A, a total of t₁ and t₂ [t₁+t₂] is preferably 45% or less of the grain size of the crystal grain, may be 30% or less of the grain size of the crystal grain, or may be 20% or less of the grain size of the crystal grain. In other words, the portion with high Sn concentration in the crystal grain α is preferably a region within 45% or less of the grain size of the crystal grain from its surface side in the cross section, may be a region within 30% or less of the grain size of the crystal grain from its surface side in the cross section, or may be a region within 20% or less of the grain size of the crystal grain from its surface side in the cross section. Preferably, Sn is not detected in the central portion of the crystal grain α. “Sn is not detected” means that the amount of Sn in terms of SnO₂ in 100 wt % of the oxide components constituting the crystal grain is less than 0.30 wt %.

In the ferrite composition according to the present embodiment, the main phase can include crystal grains with uniform Si concentration and crystal grains with higher Si concentration on the surface side than in the central portion. In observation of an observation region of 6 μm (length) by 6 μm (width) of the ferrite composition according to the present embodiment at a magnification of 20000, the proportion of the area occupied by the crystal grains with higher Si concentration on the surface side than in the central portion is preferably 30% or more and is more preferably 50% or more. Because the central portion of each of the crystal grains with higher Si concentration on the surface side than in the central portion has relatively low Si concentration and relatively high Fe concentration, the ferrite composition including these crystal grains can maintain excellent DC bias characteristic and permittivity. In the main phase, the location of the crystal grains with higher Si concentration on the surface side than in the central portion is not limited.

Here, the Si concentration means the concentration of SiO₂ in 100 wt % of oxide components constituting each of the crystal grains. The oxide components constituting the crystal grain are not limited, but include, for example, Fe₂O₃, CuO, ZnO, NiO, SiO₂, SnO₂, Bi₂O₃, and Co₃O₄. High Si concentration means that the amount of Si in terms of SiO₂ in 100 wt % of the oxide components constituting the crystal grain is preferably 0.15 wt % or more, more preferably 0.17 wt % or more, and still more preferably 0.19 wt % or more. In the present embodiment, a portion with high Si concentration in the crystal grain is, as is the case with the portion with high Sn concentration, preferably a region within 45% or less of the grain size of the crystal grain from its surface side in the cross section, may be a region within 30% or less of the grain size of the crystal grain from its surface side in the cross section, or may be a region within 20% or less of the grain size of the crystal grain from its surface side in the cross section. Preferably, Si is not detected in the central portion of the crystal grain with higher Si concentration on the surface side than in the central portion. “Si is not detected” means that the amount of Si in terms of SiO₂ in 100 wt % of the oxide components constituting the crystal grain is less than 0.15 wt %.

In the present embodiment, the crystal grains with higher Sn concentration on the surface side than in the central portion tend to have higher Si concentration on the surface side. That means, in the present embodiment, the above-mentioned crystal grains α tend to have higher Si concentration on the surface side than in the central portion. Including the crystal grains with not only higher Sn concentration but also higher Si concentration on the surface side than in the central portion in the ferrite composition according to the present embodiment allows for reduction of relative permittivity and increase in DC bias characteristic.

Next, a method of manufacturing the ferrite composition according to the present embodiment is described. First, starting raw materials (raw materials of the main component and raw materials of the subcomponent) are weighed to have a predetermined composition ratio. The starting raw materials preferably have an average grain size of 0.05 to 3.00 μm.

The raw materials of the main component can be iron oxide (α-Fe₂O₃), copper oxide (CuO), nickel oxide (NiO), zinc oxide (ZnO), a composite oxide, etc. This composite oxide is, for example, zinc silicate (Zn₂SiO₄). Moreover, it is possible to use various compounds or so to be the above-mentioned oxides or composite oxide by firing. Examples of materials to be the above-mentioned oxides by firing include a metal single substance, carbonate, oxalate, nitrate, hydroxide, halide, and an organometallic compound.

The raw materials of the subcomponent can be silicon oxide, tin oxide, bismuth oxide, and cobalt oxide. The oxide to be the raw materials of the subcomponent is not limited and can be a composite oxide or so. This composite oxide is, for example, zinc silicate (Zn₂SiO₄). Moreover, it is possible to use various compounds or so to be the above-mentioned oxides or composite oxide by firing. Examples of materials to be the above-mentioned oxides by firing include a metal single substance, carbonate, oxalate, nitrate, hydroxide, halide, and an organometallic compound.

Co₃O₄ (a form of cobalt oxide) is favorable as a raw material of the cobalt compound because Co₃O₄ is easily stored and handled and is stable in terms of its valence even in the air.

First, iron oxide, copper oxide, nickel oxide, and zinc oxide, which are the raw materials of the main component, are mixed to obtain a raw material mixture. Among the above-mentioned raw materials of the main component, zinc oxide may be partly added at this stage and the remainder may be added after the raw material mixture is calcined, or, zinc oxide might not be added at this stage and may be added along with zinc silicate after the raw material mixture is calcined. Also at this stage, a part of the raw materials of the subcomponent may be mixed with the raw materials of the main component. Here, tin oxide and silicon oxide to be the raw materials of the subcomponent may be added at this stage, but may also be added after the raw material mixture is calcined. When tin oxide and silicon oxide are added at this stage and mixed, adjusting a heating temperature in calcining makes it easier to obtain the ferrite composition having the crystal grains with higher Sn concentration and higher Si concentration on the grain surface side than in the central portion.

Mixing is carried out with any method, such as wet mixing using a ball mill and a dry mixing using a dry mixer.

Next, the raw material mixture is calcined to obtain a calcined material. Calcination causes thermal decomposition of the raw materials, homogenization of the components, generation of ferrite, and disappearance of ultrafine powder and grain growth to appropriate grain size through sintering. Calcination is carried out for conversion of the raw material mixture into a form suitable for subsequent steps. Calcination time and temperature are freely determined. When tin oxide and silicon oxide to be the raw materials of the subcomponent are added before the raw material mixture is calcined, the calcination temperature is preferably 850° C. or lower and more preferably 820° C. or lower, in terms of obtaining the ferrite composition having the crystal grains with higher Sn concentration and higher Si concentration on the grain surface side than in the central portion. Calcination is normally carried out in the atmosphere (air), but may be carried out in an atmosphere whose oxygen partial pressure is lower than that of the atmosphere (air).

Next, the calcined material is mixed with tin oxide, silicon oxide, bismuth oxide, cobalt oxide, zinc silicate, etc. to be the raw materials of the subcomponent so as to manufacture a mixed calcined material. Preferably, tin oxide and silicon oxide to be the raw materials of the subcomponent are added at this stage in the present embodiment. Adding tin oxide and silicon oxide to the calcined material and mixing together makes it easier to obtain the ferrite composition having the crystal grains with higher Sn concentration and higher Si concentration on the grain surface side than in the central portion.

Next, the mixed calcined material is pulverized to obtain a pulverized calcined material. Pulverization is carried out for crushing the aggregation of the mixed calcined material and turning it into a powder having an appropriate sinterability. When the mixed calcined material forms a large lump, rough pulverization is carried out, and then wet pulverization is carried out using a ball mill, an attritor, or the like. Wet pulverization is carried out until the pulverized calcined material preferably has an average grain size of about 0.1 to 1.0 μm.

Hereinafter, a method of manufacturing the multilayer chip coil 1 shown in FIG. 1 using the above-mentioned pulverized material after being pulverized in a wet manner is described.

The multilayer chip coil 1 shown in FIG. 1 can be manufactured with a normal manufacturing method. That is, the chip body 4 can be formed in such a manner that an internal-electrode paste containing Ag or so and a ferrite paste obtained by kneading the pulverized calcined material with a binder and a solvent are alternately printed and laminated and are thereafter fired (printing method). Instead, the chip body 4 may be formed in such a manner that the internal-electrode paste is printed on surfaces of green sheets manufactured using the ferrite paste, and the green sheets are laminated and fired (sheet method). In any case, the terminal electrodes 5 can be formed by firing, plating, or the like after the chip body is formed.

Each amount of the binder and the solvent in the ferrite paste is not limited. For example, in 100 wt % of the entire ferrite paste, the amount of the binder can be about 1 to 10 wt %, and the amount of the solvent can be about 10 to 50 wt %. If necessary, the ferrite paste may contain 10 wt % or less of a dispersant, a plasticizer, a dielectric, an insulator, etc. The internal-electrode paste containing Ag or so can be manufactured in a similar manner. While the firing conditions and the like are not limited, the firing temperature is preferably 930° C. or lower and more preferably 900° C. or lower when the internal electrode layers contain Ag or so.

The present invention is not limited to the above-described embodiment and can be modified variously within the scope of the present invention.

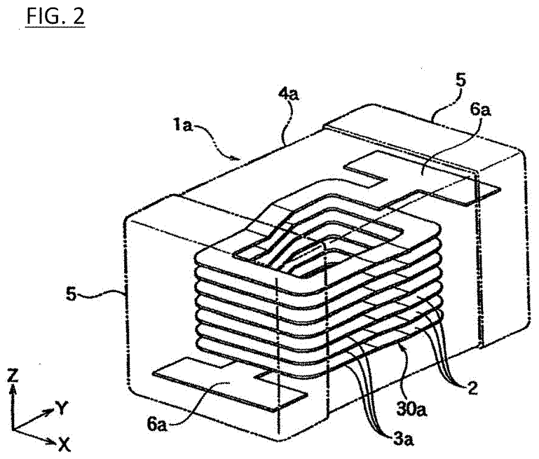

For example, ceramic layers 2 of a multilayer chip coil 1a shown in FIG. 2 may be composed of the ferrite composition of the above-mentioned embodiment. The multilayer chip coil 1a shown in FIG. 2 includes a chip body 4a containing the ceramic layers 2 and internal electrode layers 3a alternately laminated in the Z-axis direction.

Each of the internal electrode layers 3a has a square ring shape, a C shape, or a U shape. The internal electrode layers 3a are spirally connected with a stepped electrode or a through-hole electrode (not shown in the figure) penetrating the adjacent ceramic layers 2 to connect the internal electrodes, constituting a coil conductor 30a.

The terminal electrodes 5 and 5 are formed on both ends of the chip body 4a in the Y-axis direction. Each of the terminal electrodes 5 is connected to an end of a leading electrode 6a located at the top and bottom in the Z-axis direction and is thereby connected to each end of the coil conductor 30a forming a closed magnetic circuit coil.

In the present embodiment, the ceramic layers 2 and the internal electrode layers 3a are laminated in the Z-axis direction, and the end surfaces of the terminal electrodes 5 and 5 are parallel to the X-axis and the Z-axis. The X-axis, the Y-axis, and the Z-axis are perpendicular to each other. In the multilayer chip coil 1a shown in FIG. 2, the winding axis of the coil conductor 30a substantially corresponds to the Z-axis.

In the multilayer chip coil 1 shown in FIG. 1, the winding axis of the coil conductor 30 is in the Y-axis direction (the longitudinal direction of the chip body 4). Thus, compared to the multilayer chip coil 1a shown in FIG. 2, the multilayer chip coil 1 shown in FIG. 1 can have a large winding number and is advantageous in easy achievement of high impedance even in a high frequency band. In the multilayer chip coil 1a shown in FIG. 2, other configurations and effects are similar to those of the multilayer chip coil 1 shown in FIG. 1.

The ferrite composition of the present embodiment can be used for electronic components other than the multilayer chip coil shown in FIG. 1 or FIG. 2. For example, the ferrite composition of the present embodiment can be used as ceramic layers laminated together with a coil conductor. In addition, the ferrite composition of the present embodiment can be used for a composite electronic component (e.g., LC composite component) combining a coil with another element (e.g., capacitor).

The multilayer chip coil using the ferrite composition of the present embodiment is used for any purposes, but is favorably used for, for example, a circuit where a winding-wire-type ferrite inductor has been conventionally used so as to flow a particularly high AC current, such as a circuit of ICT devices (e.g., smartphones) using, for example, NFC technology or contact free charging.

### Examples

Hereinafter, the present invention is described based on more detailed examples, but is not limited to the following examples.

### Example 1

As raw materials of a main component, Fe₂O₃, NiO, CuO, and ZnO were prepared. As raw materials of a subcomponent, SiO₂, Zn₂SiO₄, SnO₂, and Bi₂O₃ were prepared. The starting raw materials had an average grain size of 0.05 to 3.00 μm.

Next, powders of the prepared raw materials of the main component and the subcomponent were weighed to have the compositions of No. 1 to No. 66 in Table 1(1) and Table 1(2) as sintered bodies.

After weighing, Fe₂O₃, NiO, CuO, and as necessary, a part of ZnO from the prepared raw materials of the main component were mixed in a wet manner in a ball mill for 16 hours so as to obtain a raw material mixture. Regarding each of samples No. 63 to No. 66, NiO was not included in the prepared raw materials of the main component.

The obtained raw material mixture was dried and then calcined in the air to obtain a calcined material. The calcination temperature was appropriately selected from a range of 500 to 900° C. in accordance with the composition of the raw material mixture. After that, the calcined material was pulverized in a ball mill while the remainder of ZnO that was not added in the above-mentioned wet mixing step and the raw materials of the subcomponent, namely SiO₂, Zn₂SiO₄, SnO₂, and Bi₂O₃ were added, so as to obtain a pulverized calcined material.

Next, the pulverized calcined material was dried. Then, 10.0 parts by weight of a polyvinyl alcohol aqueous solution (weight concentration: 6%) as a binder was added to 100 parts by weight of the pulverized calcined material, and the pulverized calcined material was granulated to be granules. These granules were pressed to obtain a pressed body having a toroidal shape (dimensions: outer diameter 13 mm×inner diameter 6 mm×height 3 mm) and a pressed body having a disk shape (dimensions: outer diameter 12 mm×height 2 mm).

The pressed bodies were fired in the air for two hours at a temperature ranging from 860 to 900° C., which was equal to or lower than the melting point (962° C.) of Ag, and a toroidal core sample and a disk sample as sintered bodies were obtained. Moreover, the following properties evaluation was carried out for each of the obtained samples. Using an X-ray fluorescence analyzer, it was confirmed that almost nothing changed between the compositions of the weighed raw material powders and the fired bodies.

### Density

Density of the ferrite composition was calculated from the dimensions and weight of the fired sintered body of the toroidal core sample. Sinterability was deemed good when the density was 4.20 g/cm³ or more.

### Permeability μ′

Permeability μ′ of the toroidal core sample was measured using an RF impedance material analyzer (E4991A manufactured by Agilent Technologies) and a test fixture (16454A manufactured by Agilent Technologies). As the measurement conditions, the measurement frequency was 10 MHz, and the measurement temperature was 25° C.

### Relative Permittivity ε

An In—Ga electrode was applied on both sides of the disk sample as the sintered body, and a capacitance “C” was measured with an LCR meter (4285A manufactured by HEWLETT PACKARD) under conditions including a measurement temperature of 20° C., a frequency of 1 MHz, and a measurement signal level of 1 Vrms. From the calculated capacitance “C,” an electrode area of the sintered body, and a distance between the electrodes, relative permittivity ε (no unit) was calculated. Relative permittivity ε of the sample was deemed good when its value was lower than the value of a sample that had a similar composition but excluded SiO₂ or SnO₂.

### DC Bias Characteristic Idc

A copper wire was wound around the toroidal core sample by 20 turns, and permeability μ′ under application of a DC current was measured using an LCR meter (4284A manufactured by HEWLETT PACKARD). As the measurement conditions, the measurement frequency was 1 MHz, and the measurement temperature was 25° C. Permeability was measured while the applied DC current was changed from 0 A to 8 A and was graphed with the DC current on the horizontal axis and the permeability on the vertical axis. Then, an electric current value at the time when the permeability decreased by 10% compared to the permeability value at the time when a DC current of 0 A was applied was defined as an Idc. DC bias characteristic was deemed good when the Idc was 1.0 A or more. When the permeability μ did not decrease by 10% with the application of a DC current of 0 A to 8 A, the Idc was deemed to exceed 8.0 A (>8.0 A).

### Specific resistance ρ

The In—Ga electrode was applied on both sides of the disk sample, a DC resistance value was measured, and specific resistance ρ was calculated (unit: Ω·m). The measurement was performed with an IR meter (R8340 manufactured by ADC). Specific resistance ρ was deemed good when it was 1.0×10⁶Ω·m or more (1.0E+06Ω·m or more).

TABLE 1(1)

| | | | | | | | | Properties | | | | |
|---|---|---|---|---|---|---|---|---|---|---|---|---|
| | Main component | | | | Subcomponent | | | | | Relative | DC bias | Specific |
| Sample | mol % | | | | Parts by weight | | | Density | Permeability | permittivity | characteristic | resistance |
| No. | Fe₂O₃ | NiO | CuO | ZnO | SiO₂ | SnO₂ | Bi₂O₃ | (g/cm³) | μ′ | ε | Idc (A) | ρ (Ωm) |
| *1 | 46.0 | 26.0 | 9.5 | 18.5 | 0.00 | 2.5 | 1.7 | 5.21 | 74.7 | 14.1 | 0.4 | 1.6E+07 |
| 2 | 44.5 | 26.0 | 9.5 | 20.0 | 0.53 | 2.5 | 1.7 | 5.16 | 43.4 | 13.2 | 1.1 | 9.7E+07 |
| 3 | 42.6 | 24.0 | 8.9 | 24.5 | 2.05 | 2.5 | 1.7 | 5.11 | 24.4 | 12.6 | 2.4 | 5.4E+07 |
| 4 | 37.0 | 20.8 | 8.0 | 34.2 | 5.51 | 2.5 | 1.7 | 4.92 | 11.8 | 11.2 | 5.3 | 4.5E+07 |
| 5 | 33.0 | 18.0 | 8.0 | 41.0 | 8.35 | 2.5 | 1.7 | 4.72 | 7.8 | 10.8 | 6.6 | 4.1E+06 |
| 6 | 33.0 | 18.0 | 8.0 | 41.0 | 11.00 | 2.5 | 1.7 | 4.25 | 5.7 | 9.8 | 7.4 | 1.0E+06 |
| *7 | 33.0 | 18.0 | 8.0 | 41.0 | 12.00 | 2.5 | 1.7 | 4.03 | 5.3 | 9.3 | 7.5 | 9.1E+05 |
| *8 | 42.6 | 24.0 | 8.9 | 24.5 | 0.00 | 2.5 | 1.7 | 5.37 | 91.6 | 16.8 | 0.5 | 4.0E+05 |
| 9 | 42.6 | 24.0 | 8.9 | 24.5 | 0.53 | 2.5 | 1.7 | 5.32 | 50.0 | 15.0 | 1.0 | 1.8E+06 |
| 3 | 42.6 | 24.0 | 8.9 | 24.5 | 2.05 | 2.5 | 1.7 | 5.11 | 24.4 | 12.6 | 2.4 | 5.4E+07 |
| 10 | 42.6 | 24.0 | 8.9 | 24.5 | 5.51 | 2.5 | 1.7 | 4.94 | 18.2 | 11.7 | 2.5 | 3.7E+07 |
| 11 | 42.6 | 24.0 | 8.9 | 24.5 | 8.35 | 2.5 | 1.7 | 4.83 | 15.0 | 11.2 | 2.7 | 3.3E+08 |
| 12 | 42.6 | 24.0 | 8.9 | 24.5 | 11.00 | 2.5 | 1.7 | 4.46 | 13.5 | 10.5 | 2.3 | 9.7E+06 |
| *13 | 37.0 | 20.8 | 8.0 | 34.2 | 5.51 | 0.0 | 1.7 | 4.88 | 13.2 | 12.7 | 5.0 | 3.6E+05 |
| 14 | 37.0 | 20.8 | 8.0 | 34.2 | 5.51 | 0.4 | 1.7 | 4.83 | 12.9 | 12.5 | 5.1 | 1.3E+06 |
| 15 | 37.0 | 20.8 | 8.0 | 34.2 | 5.51 | 0.8 | 1.7 | 4.87 | 12.6 | 12.0 | 5.1 | 4.1E+06 |
| 4 | 37.0 | 20.8 | 8.0 | 34.2 | 5.51 | 2.5 | 1.7 | 4.92 | 11.8 | 11.2 | 5.3 | 4.5E+07 |
| 16 | 37.0 | 20.8 | 8.0 | 34.2 | 5.51 | 3.8 | 1.7 | 4.87 | 11.5 | 11.0 | 5.3 | 6.0E+07 |
| 17 | 37.0 | 20.8 | 8.0 | 34.2 | 5.51 | 6.8 | 1.7 | 4.27 | 8.5 | 9.3 | 5.5 | 2.0E+06 |
| *18 | 42.6 | 24.0 | 8.9 | 24.5 | 2.05 | 0.0 | 1.8 | 5.19 | 29.9 | 15.2 | 2.2 | 9.6E+05 |
| 19 | 42.6 | 24.0 | 8.9 | 24.5 | 2.05 | 0.1 | 1.8 | 5.27 | 32.0 | 15.0 | 2.1 | 2.1E+06 |
| 20 | 42.6 | 24.0 | 8.9 | 24.5 | 2.05 | 0.4 | 1.8 | 5.22 | 31.5 | 14.8 | 2.0 | 4.0E+06 |
| 21 | 42.6 | 24.0 | 8.9 | 24.5 | 2.05 | 0.9 | 1.8 | 5.22 | 28.8 | 13.9 | 2.1 | 1.4E+07 |
| 22 | 42.6 | 24.0 | 8.9 | 24.5 | 2.05 | 2.1 | 1.8 | 5.15 | 25.8 | 13.0 | 2.3 | 3.9E+07 |
| 3 | 42.6 | 24.0 | 8.9 | 24.5 | 2.05 | 2.5 | 1.8 | 5.11 | 24.4 | 12.6 | 2.4 | 5.4E+07 |
| *23 | 37.4 | 29.2 | 8.9 | 24.5 | 2.05 | 0.0 | 1.9 | 5.35 | 24.0 | 24.4 | 2.7 | 3.7E+04 |
| 24 | 37.4 | 29.2 | 8.9 | 24.5 | 2.05 | 9.4 | 1.9 | 5.26 | 12.6 | 12.4 | 3.8 | 3.9E+07 |
| 25 | 37.4 | 29.2 | 8.9 | 24.5 | 2.05 | 11.3 | 1.9 | 4.88 | 9.1 | 13.6 | 4.5 | 2.6E+06 |
| *26 | 37.4 | 29.2 | 8.9 | 24.5 | 2.05 | 14.2 | 1.9 | 4.53 | 7.4 | 12.1 | 4.8 | 4.8E+05 |
| *27 | 33.0 | 19.4 | 8.1 | 39.5 | 5.51 | 0.0 | 2.6 | 5.18 | 16.7 | 26.8 | 3.1 | 2.3E+04 |
| 28 | 33.0 | 19.4 | 8.1 | 39.5 | 5.51 | 6.0 | 2.6 | 5.24 | 13.1 | 14.5 | 3.3 | 1.4E+06 |
| 29 | 33.0 | 19.4 | 8.1 | 39.5 | 5.51 | 8.5 | 2.6 | 4.99 | 9.4 | 10.9 | 3.4 | 7.0E+09 |
| 30 | 33.0 | 19.4 | 8.1 | 39.5 | 5.51 | 11.1 | 2.6 | 4.73 | 7.3 | 9.9 | 3.8 | 1.3E+07 |
| 31 | 33.0 | 19.4 | 8.1 | 39.5 | 5.51 | 12.8 | 2.6 | 4.50 | 5.9 | 9.6 | 3.9 | 2.5E+06 |

Samples marked with “*” are comparative examples.

TABLE 1(2)

| | | | | | | | | Properties | | | | |
|---|---|---|---|---|---|---|---|---|---|---|---|---|
| | Main component | | | | Subcomponent | | | | | Relative | DC bias | Specific |
| Sample | mol % | | | | Parts by weight | | | Density | Permeability | permittivity | characteristic | resistance |
| No. | Fe₂O₃ | NiO | CuO | ZnO | SiO₂ | SnO₂ | Bi₂O₃ | (g/cm³) | μ′ | ε | Idc (A) | ρ (Ωm) |
| *32 | 37.0 | 20.8 | 8.0 | 34.2 | 0.00 | 2.5 | 1.7 | 5.44 | 60.9 | 24.6 | 0.6 | 9.8E+04 |
| *33 | 37.0 | 20.8 | 8.0 | 34.2 | 5.51 | 2.5 | 0.0 | 3.85 | — | — | — | 4.9E+04 |
| 34 | 37.0 | 20.8 | 8.0 | 34.2 | 5.51 | 2.5 | 0.5 | 4.65 | 11.2 | 12.6 | 5.4 | 1.4E+06 |
| 35 | 37.0 | 20.8 | 8.0 | 34.2 | 5.51 | 2.5 | 1.1 | 4.80 | 11.4 | 11.7 | 5.4 | 2.0E+07 |
| 4 | 37.0 | 20.8 | 8.0 | 34.2 | 5.51 | 2.5 | 1.7 | 4.92 | 11.8 | 11.2 | 5.3 | 4.5E+07 |
| 36 | 37.0 | 20.8 | 8.0 | 34.2 | 5.51 | 2.5 | 3.0 | 5.09 | 12.5 | 12.0 | 5.1 | 3.8E+07 |
| 37 | 37.0 | 20.8 | 8.0 | 34.2 | 5.51 | 2.5 | 3.8 | 5.15 | 12.8 | 12.6 | 4.9 | 2.6E+07 |
| 38 | 37.0 | 20.8 | 8.0 | 34.2 | 5.51 | 2.5 | 4.5 | 5.17 | 12.9 | 13.7 | 4.8 | 8.3E+06 |
| 39 | 37.0 | 20.8 | 8.0 | 34.2 | 5.51 | 2.5 | 7.0 | 5.20 | 12.8 | 23.2 | 4.8 | 1.3E+06 |
| *40 | 37.0 | 20.8 | 8.0 | 34.2 | 5.51 | 2.5 | 8.5 | 5.24 | 13.2 | 29.3 | 4.7 | 3.7E+05 |
| *41 | 30.0 | 27.8 | 8.0 | 34.2 | 5.51 | 2.5 | 1.7 | 5.16 | 9.6 | 19.3 | 5.6 | 8.2E+04 |
| *42 | 32.0 | 25.8 | 8.0 | 34.2 | 5.51 | 0.0 | 1.7 | 5.17 | 12.4 | 19.0 | 5.2 | 8.8E+04 |
| 43 | 32.0 | 25.8 | 8.0 | 34.2 | 5.51 | 2.5 | 1.7 | 5.14 | 10.6 | 15.8 | 5.6 | 1.4E+06 |
| *44 | 38.3 | 19.5 | 8.0 | 34.2 | 5.51 | 0.0 | 1.7 | 4.92 | 14.5 | 11.7 | 4.7 | 2.7E+08 |
| 45 | 38.3 | 19.5 | 8.0 | 34.2 | 5.51 | 2.5 | 1.7 | 4.56 | 12.7 | 10.6 | 4.3 | 3.3E+06 |
| *46 | 44.5 | 22.0 | 9.1 | 24.4 | 2.05 | 0.0 | 2.0 | 5.16 | 32.2 | 13.4 | 2.0 | 1.8E+08 |
| 47 | 44.5 | 22.0 | 9.1 | 24.4 | 2.05 | 1.0 | 2.0 | 4.95 | 29.7 | 12.4 | 2.0 | 1.2E+08 |
| 48 | 46.0 | 23.9 | 9.1 | 21.0 | 1.05 | 1.0 | 2.0 | 5.01 | 44.3 | 12.9 | 1.2 | 8.4E+07 |
| 49 | 46.4 | 23.5 | 9.1 | 21.0 | 0.80 | 1.0 | 2.0 | 5.00 | 51.5 | 13.0 | 1.0 | 1.5E+08 |
| *50 | 46.8 | 23.1 | 9.1 | 21.0 | 0.53 | 1.0 | 2.0 | 5.05 | 61.8 | 13.2 | 0.7 | 5.0E+07 |
| *51 | 37.0 | 24.4 | 4.4 | 34.2 | 5.51 | 0.0 | 1.7 | 4.87 | 12.4 | 15.0 | 5.6 | 5.7E+04 |
| 52 | 37.0 | 24.4 | 4.4 | 34.2 | 5.51 | 2.5 | 1.7 | 4.78 | 10.2 | 13.3 | 5.3 | 1.2E+06 |
| *53 | 37.0 | 14.8 | 14.0 | 34.2 | 5.51 | 0.0 | 1.7 | 4.96 | 12.8 | 14.9 | 5.1 | 4.3E+05 |
| 54 | 37.0 | 14.8 | 14.0 | 34.2 | 5.51 | 2.5 | 1.7 | 4.86 | 10.8 | 12.9 | 6.2 | 4.0E+06 |
| *55 | 43.5 | 42.6 | 5.5 | 8.4 | 2.05 | 0.0 | 2.0 | 5.08 | 13.2 | 16.2 | 3.2 | 41E+04 |
| 56 | 43.5 | 42.6 | 5.5 | 8.4 | 2.05 | 3.8 | 2.0 | 4.76 | 10.4 | 13.8 | 4.2 | 1.1E+06 |
| *57 | 41.2 | 40.6 | 5.0 | 13.2 | 3.42 | 0.0 | 2.0 | 5.16 | 11.7 | 14.0 | 4.4 | 4.9E+05 |
| 58 | 41.2 | 40.6 | 5.0 | 13.2 | 3.42 | 3.6 | 2.0 | 4.71 | 10.4 | 13.6 | 4.4 | 1.7E+06 |
| *59 | 37.0 | 35.0 | 8.0 | 20.0 | 5.51 | 0.0 | 1.7 | 5.07 | 7.5 | 13.8 | 7.3 | 1.6E+05 |
| 60 | 37.0 | 35.0 | 8.0 | 20.0 | 5.51 | 2.5 | 1.7 | 4.87 | 7.3 | 12.1 | 6.5 | 1.7E+06 |
| *61 | 37.0 | 11.5 | 8.0 | 43.5 | 5.51 | 0.0 | 1.7 | 5.00 | 19.6 | 12.8 | 3.0 | 8.6E+06 |
| 62 | 37.0 | 11.5 | 8.0 | 43.5 | 5.51 | 2.5 | 1.7 | 4.97 | 17.1 | 11.6 | 2.9 | 9.0E+08 |
| *63 | 43.3 | 0.0 | 11.9 | 44.8 | 2.05 | 0.0 | 1.8 | 5.28 | 1.0 | 15.2 | >8.0 | 7.9E+07 |
| 64 | 43.3 | 0.0 | 11.9 | 44.8 | 2.05 | 2.5 | 1.8 | 5.16 | 1.0 | 13.9 | >8.0 | 3.6E+07 |
| *65 | 34.0 | 0.0 | 9.1 | 56.9 | 8.35 | 0.0 | 2.3 | 4.98 | 1.0 | 12.2 | >8.0 | 5.8E+08 |
| 66 | 34.0 | 0.0 | 9.1 | 56.9 | 8.35 | 2.5 | 2.3 | 4.84 | 1.0 | 11.4 | >8.0 | 1.9E+07 |

Samples marked with “*” are comparative examples.

In each of No. 1 to No. 12 of Table 1(1), mainly the amount of the silicon compound in terms of SiO₂ was changed. In No. 2 to No. 6 and No. 9 to No. 12, all properties were good, namely density, permeability, relative permittivity, DC bias characteristic, and specific resistance. On the other hand, No. 1 with too little amount of the silicon compound had inferior DC bias characteristic, and No. 8 with too little amount of the silicon compound had inferior DC bias characteristic and inferior specific resistance. No. 7 with too much amount of the silicon compound had inferior specific resistance and inferior density.

In each of No. 13 to No. 31 of Table 1(1), mainly the amount of the tin compound in terms of SnO₂ was changed. In No. 14 to No. 17, No. 19 to No. 22, No. 24, No.25, and No. 28 to No. 31, all properties were good, namely density, permeability, relative permittivity, DC bias characteristic, and specific resistance. On the other hand, each of Nos. 13, 18, 23, and 27 with too little amount of the tin compound and No. 26 with too much amount of the tin compound had inferior specific resistance.

In each of No. 32 to No. 40 of Table 1(2), mainly the amount of the bismuth compound in terms of Bi₂O₃ was changed. In No. 34 to No. 39, all properties were good, namely density, permeability, relative permittivity, DC bias characteristic, and specific resistance. On the other hand, in No. 33 with too little amount of the bismuth compound, density was too small, which made it impossible to evaluate permeability, relative permittivity, and DC bias characteristic. No. 33 also had inferior specific resistance. No. 40 with too much amount of the bismuth compound had inferior relative permittivity and inferior specific resistance.

In each of No. 41 to No. 66 of Table 1(2), mainly the composition of the main component was changed. In Nos. 43, 45, 47 to 49, 52, 54, 56, 58, 60, 62, 64, and 66, all properties were good, namely density, permeability, relative permittivity, DC bias characteristic, and specific resistance. On the other hand, No. 41 with too little amount of iron oxide had inferior specific resistance. No. 50 with too much amount of iron oxide had inferior DC bias characteristic.

### Example 2

As the raw material of the subcomponent, Co₃O₄ was further prepared and weighed to have the compositions of No. 67 to No. 76 shown in Table 2 as the sintered body. Co₃O₄ and the raw materials of the subcomponent, namely SiO₂, Zn₂SiO₄, SnO₂, and Bi₂O₃ were added to the calcined material of the main component, and the calcined material was pulverized in a ball mill. A pulverized calcined material was thus obtained. Other preparation conditions were similar to those in Example 1. Under such conditions, pressed bodies were obtained. Evaluation was performed in the same manner as in Example 1. Table 2 shows the results.

TABLE 2

| | | | | | | | | | Properties | | | | |
|---|---|---|---|---|---|---|---|---|---|---|---|---|---|
| | Main component | | | | Subcomponent | | | | | | Relative | DC bias | Specific |
| Sample | mol % | | | | Parts by weight | | | | Density | Permeability | permittivity | characteristic | resistance |
| No. | Fe₂O₃ | NiO | CuO | ZnO | SiO₂ | SnO₂ | Bi₂O₃ | Co₃O₄ | (g/cm³) | μ′ | ε | Idc (A) | ρ (Ωm) |
| *67 | 42.4 | 24.0 | 8.9 | 24.7 | 2.05 | 0.0 | 1.6 | 0.0 | 5.19 | 29.9 | 15.2 | 2.2 | 1.0E+06 |
| 68 | 42.4 | 24.0 | 8.9 | 24.7 | 2.05 | 3.8 | 1.6 | 0.0 | 5.05 | 22.2 | 12.3 | 2.7 | 4.9E+07 |
| 69 | 42.4 | 24.0 | 8.9 | 24.7 | 2.05 | 3.8 | 1.6 | 0.01 | 5.05 | 22.1 | 12.3 | 2.7 | 5.5E+07 |
| 70 | 42.4 | 24.0 | 8.9 | 24.7 | 2.05 | 3.8 | 1.6 | 0.4 | 5.05 | 19.0 | 12.2 | 3.0 | 1.2E+09 |
| 71 | 42.4 | 24.0 | 8.9 | 24.7 | 2.05 | 3.8 | 1.6 | 4.0 | 5.11 | 9.9 | 12.7 | 4.1 | 1.3E+08 |
| 72 | 42.4 | 24.0 | 8.9 | 24.7 | 2.05 | 3.8 | 1.6 | 6.0 | 5.16 | 7.3 | 12.9 | 4.9 | 5.8E+07 |
| 73 | 42.4 | 24.0 | 8.9 | 24.7 | 2.05 | 3.8 | 1.6 | 8.0 | 5.19 | 6.5 | 13.1 | 6.0 | 6.2E+06 |
| 74 | 42.4 | 24.0 | 8.9 | 24.7 | 2.05 | 3.8 | 1.6 | 10.0 | 5.20 | 5.2 | 13.1 | >8.0 | 5.0E+06 |
| 75 | 42.4 | 24.0 | 8.9 | 24.7 | 2.05 | 3.8 | 1.6 | 12.0 | 5.22 | 4.7 | 13.2 | >8.0 | 3.6E+06 |
| 76 | 42.4 | 24.0 | 8.9 | 24.7 | 2.05 | 3.8 | 1.6 | 15.0 | 5.23 | 4.1 | 13.3 | >8.0 | 1.7E+06 |

A sample marked with “*” is a comparative example.

In each of No. 67 to No. 76 of Table 2, mainly the amount of cobalt oxide in terms of Co₃O₄ was changed. In No. 68 to No. 76, all properties were good, namely density, permeability, relative permittivity, DC bias characteristic, and specific resistance. DC bias characteristic and specific resistance were especially good.

### Example 3

The raw materials of the main component and the subcomponent were prepared in the same manner as in Example 1, and then weighed to have the compositions of No. 77 to No. 80 shown in Table 3 as the sintered bodies. Pressed bodies of Nos. 77 and 79 were obtained in the same manner as in Example 1. Evaluation was performed in the same manner as in Example 1. Table 3 shows the results.

In Nos. 78 and 80, Fe₂O₃, NiO, CuO, and as necessary, a part of ZnO as the raw materials of the main component, and SnO₂ as the raw material of the subcomponent were mixed in a wet manner in a ball mill for 16 hours so as to obtain a raw material mixture. The obtained raw material mixture was dried and then calcined in the air to obtain a calcined material. The calcination temperature was 880° C. After that, the calcined material was pulverized in a ball mill while the remainder of ZnO that was not mixed in the above-mentioned wet mixing step, SiO₂, Zn₂SiO₄, and Bi₂O₃ were added, so as to obtain a pulverized calcined material. Other preparation conditions were similar to those in Example 1. Under such conditions, pressed bodies were obtained. Evaluation was performed in the same manner as in Example 1. Table 3 shows the results.

TABLE 3

| | | | | | | | | Properties | | | | |
|---|---|---|---|---|---|---|---|---|---|---|---|---|
| | Main component | | | | Subcomponent | | | | | Relative | DC bias | Specific |
| Sample | mol % | | | | Parts by weight | | | Density | Permeability | permittivity | characteristic | resistance |
| No. | Fe₂O₃ | NiO | CuO | ZnO | SiO₂ | SnO₂ | Bi₂O₃ | (g/cm³) | μ′ | ε | Idc (A) | ρ (Ωm) |
| 77 | 42.6 | 22.5 | 8.8 | 26.1 | 2.50 | 2.8 | 1.5 | 4.76 | 20.9 | 13.0 | 2.9 | 1.6E+06 |
| 78 | 42.6 | 22.5 | 8.8 | 26.1 | 2.50 | 2.8 | 1.5 | 4.80 | 21.5 | 12.8 | 2.3 | 4.9E+07 |
| 79 | 38.1 | 21.5 | 8.2 | 32.2 | 4.71 | 3.5 | 2.1 | 4.92 | 12.4 | 11.7 | 5.2 | 7.6E+06 |
| 80 | 38.1 | 21.5 | 8.2 | 32.2 | 4.71 | 3.5 | 2.1 | 4.95 | 12.6 | 11.5 | 4.7 | 3.7E+07 |

Timing of SnO₂ addition as the raw material of the subcomponent was different between Nos. 77 and 79 and Nos. 78 and 80 of Table 3. Whereas SnO₂ was added after the raw material mixture was calcined in Nos. 77 and 79, SnO₂ was calcined together with the raw materials of the main component so as to be included in the calcined material in Nos. 78 and 80. Consequently, it was assumed that the ferrite composition including crystal grains with higher Sn concentration on a surface side than in a central portion was obtained in Nos. 77 and 79, each of which had especially good DC bias characteristic. On the other hand, in Nos. 78 and 80, crystal grains with uniform Sn concentration were easily formed, and the crystal grains with higher Sn concentration on the surface side than in the central portion were difficult to be formed. This may be why Nos. 78 and 80 had DC bias characteristic inferior to that of Nos. 77 and 79 respectively.

### Example 4

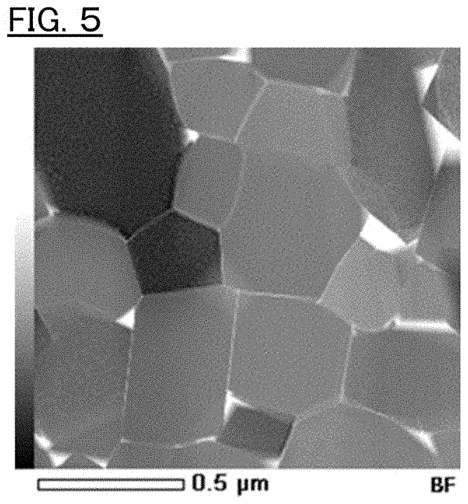

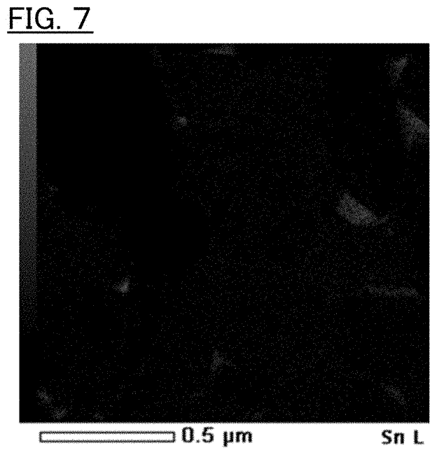

The sintered ferrite compositions (toroidal core samples) having the compositions of Nos. 16 and 13 obtained in Example 1 were observed using STEM-EDS. FIGS. 4 and 5 are STEM-EDS images of the sample of No. 16 and the sample of No. 13 respectively. As shown in FIGS. 4 and 5, it was confirmed that the samples of Nos. 16 and 13 both included crystal grains. FIGS. 6 and 7 are a Sn element mapping image of the sample of No. 16 and a Sn element mapping image of the sample of No. 13 respectively. The white area is where the Sn element exists. As shown in FIG. 6, it was confirmed that the sample of No. 16 included the crystal grains with higher Sn concentration on the grain surface side. On the other hand, as shown in FIG. 7, the Sn element was not observed in the sample of No. 13.

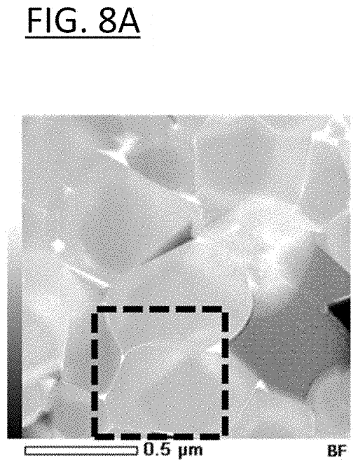

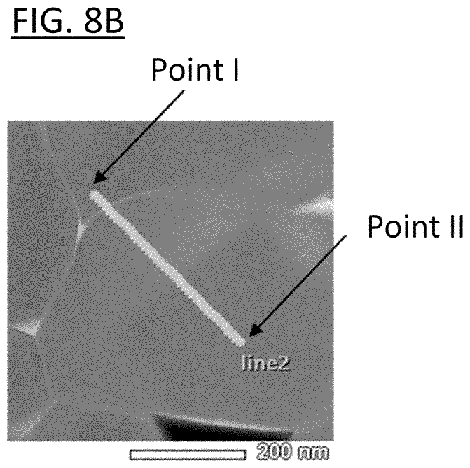

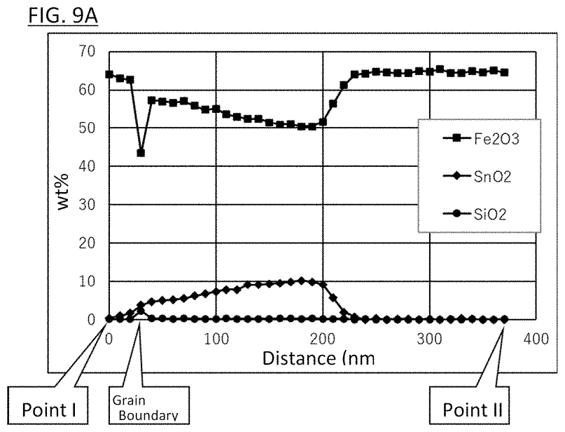

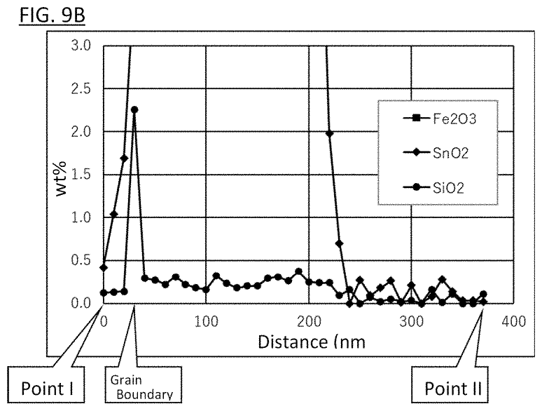

Moreover, for the sample of No. 16, the Sn concentration from the surface side to the central portion of the crystal grains was measured using STEM-EDS. FIG. 8A is a STEM-EDS image of the sample of No. 16. FIG. 8B is an enlarged view of the area in the dotted frame in FIG. 8A and shows a location of Sn concentration measurement. FIG. 9A is a graph showing changes in the amount (wt %) of Fe₂O₃, SnO₂, and SiO₂ from point I to point II in FIG. 8B. FIG. 9B is a graph same as FIG. 9A but has a magnified vertical axis. Table 4 shows the amount (wt %) of each of Fe₂O₃, CuO, ZnO, NiO, SiO₂, SnO₂, and Bi₂O₃ from point I to point II.

TABLE 4

| Distance | Concentration (wt %) | | | | | | | |
|---|---|---|---|---|---|---|---|---|
| (nm) | Fe₂O₃ | NiO | CuO | ZnO | SiO₂ | SnO₂ | Bi₂O₃ | Location |
| 0 | 64.25 | 16.15 | 5.81 | 13.22 | 0.12 | 0.42 | 0.03 | Point I |
| 10 | 63.21 | 16.05 | 6.49 | 13.08 | 0.13 | 1.04 | 0 | |
| 20 | 62.72 | 16.23 | 6.06 | 13.16 | 0.14 | 1.69 | 0 | |
| 30 | 44.99 | 12.21 | 10.72 | 11.45 | 2.34 | 3.88 | 14.41 | Grain boundary |
| 40 | 57.55 | 15.90 | 6.77 | 14.76 | 0.29 | 4.70 | 0.03 | ↓ |
| 50 | 57.22 | 15.57 | 6.62 | 15.27 | 0.27 | 5.00 | 0.05 | ↓ |
| 60 | 56.86 | 15.75 | 6.27 | 15.61 | 0.22 | 5.29 | 0 | ↓ |
| 70 | 57.24 | 15.57 | 6.08 | 15.25 | 0.31 | 5.55 | 0 | ↓ |
| 80 | 55.97 | 15.55 | 5.99 | 16.05 | 0.22 | 6.22 | 0 | ↓ |
| 90 | 54.99 | 15.44 | 6.30 | 16.37 | 0.18 | 6.72 | 0 | ↓ |
| 100 | 55.16 | 14.73 | 6.06 | 16.56 | 0.16 | 7.33 | 0 | ↓ |
| 110 | 53.76 | 15.40 | 5.94 | 16.69 | 0.32 | 7.87 | 0.02 | ↓ |
| 120 | 53.16 | 16.03 | 6.22 | 16.55 | 0.23 | 7.81 | 0 | ↓ |
| 130 | 52.55 | 14.97 | 5.95 | 17.24 | 0.18 | 9.11 | 0 | ↓ |
| 140 | 52.62 | 15.22 | 5.94 | 16.86 | 0.20 | 9.16 | 0 | ↓ |
| 150 | 51.77 | 15.74 | 5.85 | 17.02 | 0.20 | 9.42 | 0 | ↓ |
| 160 | 50.98 | 15.37 | 5.87 | 17.90 | 0.29 | 9.53 | 0.06 | ↓ |
| 170 | 51.26 | 15.52 | 5.52 | 17.44 | 0.31 | 9.95 | 0 | ↓ |
| 180 | 50.55 | 15.31 | 5.85 | 17.71 | 0.26 | 10.26 | 0.06 | ↓ |
| 190 | 50.77 | 15.18 | 5.87 | 17.72 | 0.37 | 10.00 | 0.09 | ↓ |
| 200 | 51.71 | 15.31 | 6.14 | 17.35 | 0.25 | 9.24 | 0 | ↓ |
| 210 | 56.61 | 16.31 | 5.89 | 15.21 | 0.24 | 5.69 | 0.05 | ↓ |
| 220 | 61.36 | 16.07 | 6.18 | 14.16 | 0.24 | 1.98 | 0.01 | ↓ |
| 230 | 64.15 | 15.97 | 5.63 | 13.46 | 0.09 | 0.70 | 0 | ↓ |
| 240 | 64.45 | 16.51 | 5.66 | 13.22 | 0.16 | 0 | 0 | ↓ |
| 250 | 64.82 | 16.17 | 5.61 | 13.13 | 0 | 0.27 | 0 | ↓ |
| 260 | 64.85 | 15.81 | 5.60 | 13.58 | 0.07 | 0.09 | 0 | ↓ |
| 270 | 64.63 | 15.87 | 5.81 | 13.36 | 0.02 | 0.18 | 0.13 | ↓ |
| 280 | 64.45 | 16.04 | 5.53 | 13.51 | 0.05 | 0.26 | 0.16 | ↓ |
| 290 | 65.02 | 15.87 | 5.54 | 13.54 | 0.02 | 0.01 | 0 | ↓ |
| 300 | 64.91 | 15.77 | 5.37 | 13.64 | 0.03 | 0.21 | 0.07 | ↓ |
| 310 | 65.51 | 15.68 | 5.46 | 13.35 | 0 | 0 | 0 | ↓ |
| 320 | 64.50 | 16.06 | 5.64 | 13.50 | 0.16 | 0.08 | 0.06 | ↓ |
| 330 | 64.71 | 15.98 | 5.36 | 13.66 | 0.01 | 0.28 | 0 | ↓ |
| 340 | 65.16 | 16.03 | 5.54 | 13.01 | 0.11 | 0.14 | 0.01 | ↓ |
| 350 | 64.88 | 16.15 | 5.52 | 13.42 | 0 | 0.03 | 0 | ↓ |
| 360 | 65.32 | 16.05 | 5.15 | 13.45 | 0 | 0.03 | 0 | ↓ |
| 370 | 64.81 | 16.04 | 5.64 | 13.38 | 0.11 | 0.02 | 0 | Point II |

FIG. 9A, FIG. 9B, and Table 4 show the Sn concentration and the Si concentration from point I to point II, which starts at a starting point (point I) in the vicinity of the surface of an adjacent crystal grain, crosses a grain boundary between the adjacent crystal grain and the crystal grain subject to observation, proceed to the surface side of the crystal grain subject to observation onward, and ends at a point (point II) in the central portion of the crystal grain subject to observation. From FIG. 9A, FIG. 9B, and Table 4, it was confirmed that the sample of No. 16 included the crystal grains with higher Sn concentration and higher Si concentration on the grain surface side than in the central portion.

### DESCRIPTION OF THE REFERENCE NUMERALS

1, 1a . . . multilayer chip coil
2 . . . ceramic layer
3, 3a . . . internal electrode layer
4, 4a . . . chip body
5 . . . electrode terminal
6 . . . terminal-connection through-hole electrode
6a . . . leading electrode
30, 30a . . . coil conductor

What is claimed is:

1. A ferrite composition comprising a main component and a subcomponent, wherein
the main component includes 32.0 to 46.4 mol % of iron oxide in terms of Fe₂O₃, 4.4 to 14.0 mol % of copper oxide in terms of CuO, and 8.4 to 56.9 mol % of zinc oxide in terms of ZnO; and
the subcomponent includes 0.53 to 11.00 parts by weight of a silicon compound in terms of SiO₂, 0.1 to 12.8 parts by weight of a tin compound in terms of SnO₂, and 0.5 to 7.0 parts by weight of a bismuth compound in terms of Bi₂O₃, with respect to 100 parts by weight of the main component.

2. The ferrite composition according to claim 1, wherein
the subcomponent includes 0.01 to 15.0 parts by weight of cobalt oxide in terms of Co₃O₄ with respect to 100 parts by weight of the main component.

3. The ferrite composition according to claim 1, wherein
crystal grains with higher Sn concentration on a surface side than in a central portion are included.

4. The ferrite composition according to claim 1, wherein
crystal grains with higher Si concentration on a surface side than in a central portion are included.

5. An electronic component including the ferrite composition according to claim 1.
